(19) United States
(12) Patent Application Publication
(10) Pub. No.: US 2006/0271391 A1
(43) Pub. Date: Nov. 30, 2006

(54) Multi purpose business card and method therefor

(75) Inventor: Elaine Lee, Burnaby (CA)

Correspondence Address: MORRISON & FOERSTER LLP, 12531 HIGH BLUFF DRIVE, SUITE 100, SAN DIEGO, CA, 92130-2040, US

(73) Assignee: Applied Eureka Solutions Inc., City of Burnaby (CA)

(21) Appl. No.: 11/398,502

(22) Filed: Apr. 5, 2006

Related U.S. Application Data
(60) Provisional application No. 60/684,980, filed on May 27, 2005.

(51) Int. Cl. G06Q 99/00

(52) U.S. Cl. 705/1

(57) ABSTRACT

The present invention provides a multi-purpose business card that includes contact information of a contact, as well as an e-value that can be redeemable by a recipient of the business card at a point-of-sale in exchange for wares and/or services. The e-value associated with the business card serves as an incentive for the recipient to retain and use the business card. Moreover, the contact can monitor the use of the business card and in the event of extended periods of non-use or expenditure in the amount of e-value associated with the business card in consideration for wares or services, the contact may offer to replace the card or replenish its e-value to ensure preservation and continued retention of the multi-purpose business card.

### RELATED APPLICATIONS

This application claims the benefit of priority under 35 U.S.C. § 119(e) of U.S. provisional application No. 60/684,980, filed May 27, 2005. The aforementioned application is explicitly incorporated herein by reference in its entirety and for all purposes.

### FIELD OF THE INVENTION

The present invention pertains to business cards, and more particularly to business cards which can also be served as electronic transaction cards.

### BACKGROUND

Managing contacts and maintaining business relationships are an important aspect of any business. Traditional wallet-size business cards have been universally used as an identifier of a contact and the contact's wares or services, and have long been an inexpensive, effective, and globally known way to create and maintain contact information during the course of business.

An important function of a business card is recall. The contact often presents the business card not only for purposes of introduction, but also intends that the recipient of the card preserve the card for future use and reference. However, a difficulty with the traditional business card is that unless the recipient is markedly interested in the contact information, there is little incentive for the recipient to retain the card. Aside from the information printed on the card, the card itself has no inherent value, and is often lost or neglected if the recipient is only mildly interested in the limited information provided thereon. Unless the information provided by a business card is captured in a physical or electronic catalogue, the link between the contact and the recipient is broken once the card is lost or destroyed.

A number of solutions have been proposed to provide an incentive for the recipient of the business card to retain the card. The U.S. Pat. No. 6,857,575 issued to Mathias et al. teaches an optical business card having first and a second elements, whereby the first element is an optical storage medium (for example a CD-ROM) that has a shape of a circular disk with two parallel cut edges of cut-off segments symmetrical to a center point and the second element is a business card, especially formed from synthetic resin, which is insertable in combination with the optical storage medium in a drive of a writing appliance and/or a reading appliance. Symmetrical fastening elements around the whole optical storage medium join the business card and the storage optical medium together. Although the information contained in the optical storage medium (for example a music file) may encourage the recipient to retain the optical business card, the business card disclosed is difficult to manufacture and requires the recipient to use an optical reader to access the information contained thereon.

Other solutions, such as the incorporation of holograms, color, texture or pictures on the traditional business card have been proposed to make the card more distinguishable and aesthetically pleasing, thereby encouraging the recipient to recall and use the card. However, a major difficulty with these and other types of existing business cards is that, once the card has been handed over to the intended recipient, the contact no longer has any control over the use of the card. More importantly, the contact is unable to monitor any subsequent use of the card and is unaware if the card has become lost or destroyed.

Historically, wares or services have been transacted in brick-and-mortar business settings. With the advent of e-commerce, an increasing number of business transactions are being conducted online. There is a need to further exploit the contact management capabilities of the traditional business cards in the e-commerce environment.

With the advent of e-commerce has come a plethora of sophisticated business development tools such as Personal Information Managers (PIMs) or Contact/Customer Management Systems (CSMs) of small or large scales to maintain and manage contacts. However, these tools have been relatively unsuccessful in replacing the basic functionality, universality and ease of distribution of the traditional business cards. When used in connection with a traditional business card, these tools often require manual or electronic data entry of the contact information into the system. The data entry process requires additional hardware and can become quite cumbersome for the recipient, particularly when dealing with a large number of contacts. In addition, it may introduce errors in the contact information captured during the data entry process. Lastly, due to its electronic nature, the captured contact information can be inadvertently altered or become lost, whereby the link between the contact and recipient may become broken.

A number of solutions have been proposed to electronically capture the content of traditional business cards to facilitate use of the contact information in an e-commerce setting. One example is scanning software that allows business cards with wide varieties of textual or graphical designs to be scanned and subsequently compare the information scanned with large data banks to match words on the cards. The information can be then integrated with full featured address books and synchronized with a contact management system such as Microsoft Outlook™. However, the majority of these systems require additional hardware and effort by the card's recipient to capture the contact information on a different medium. Moreover, the contact has generally no knowledge whether the contact information has been properly captured and used at a later stage.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a multi-purpose business card and method therefor. In accordance with one aspect of the present invention, there is provided a multi-purpose business card comprising a base layer defining a card, the base layer having a front side and a rear side, and the front side including contact information and the rear side including storage means having an e-value, the e-value being redeemable against a product or service.

According to another aspect of the present invention there is provided a method of contact management in an e-commerce system having a plurality of point-of-sale clients, each client having input and output means, storage means, peripheral means for reading information on a business card storage means, processing means executing a client program for communicating through a communication network through communication interface means with a server application executing on processing means, storage means having databases for storing information relating to an affinity merchant and information relating to a business card recipient's profile in data files, the server further having resource management means and network interface means for communicating with the client program, and graphical user interface means for communicating data to the server application, the method comprising the steps of: subscribing to the server; issuing a contact identification by the server; selecting participating affinity merchants; creating contact information; storing contact identification and contact information in data files; associating contact identification and contact information with the selected merchant; assigning contact identification and contact information to the business card; and issuing business cards.

According to another aspect of the present invention, there is provided a method of distribution of at least a business card for at least a contact in an e-commerce system having a plurality of point-of-sale clients, each client having input and output means, storage means, peripheral means for reading at least a contact information on the at least a business card storage means, processing means executing a client program for communicating through a communication network through communication interface means with a server application executing on processing means, storage means having databases for storing information relating to at least a merchant and information relating to the at least a business card recipient's profile in data files, the server further having resource management means and network interface means for communicating with the client program, and graphical user interface means for communicating data to the server application, the method comprising the steps of: providing the at least a business card to a recipient; and activating the business card by creating a recipient profile in the data files.

According to yet another aspect of the present invention, there is provided a method of using of at least a business card for at least a contact in an e-commerce system having a plurality of point-of-sale (POS) clients, each client having input and output means, storage means, peripheral means for reading at least a contact information on the at least a business card storage means, processing means executing a client program for communicating through a communication network through communication interface means with a server application executing on processing means, storage means having databases for storing information relating to at least a merchant and information relating to the at least a business card recipient's profile in data files, the server further having resource management means and network interface means for communicating with the client program, and graphical user interface means for communicating data to the server application, the method comprising the steps of: providing the at least a business card a POS client associated with the at least a merchant to effectuate a transaction at the POS client; reading the information relating to at least a business card's recipient; communicating the information relating to at least a business card's recipient information to the server application; locating and downloading the at least a business card's recipient's profile from the databases; verifying whether the at least a business card contains sufficient e-value for the requested transaction; and approving the transaction if the amount of e-value residing on the business card is equal or greater than the actual value of the ware or service that is the subject of the transaction.

### BRIEF DESCRIPTION OF THE FIGURES

A better understanding of these and other embodiments of the present invention can be obtained with reference to the following drawings which show by way of embodiments of the present invention, in which:

FIGS. 1(a) and 1(b) are front and rear views of a multi-purpose business card according to an embodiment of the present invention;

FIG. 1(c) is the front view of a multi-purpose business card according to another embodiment of the present invention;

FIG. 2 is a diagrammatic representation of a contact management system according to an embodiment of the present invention;

FIG. 3 is a block diagram of a point-of-sale client;

FIG. 4 is a block diagram of a server;

FIG. 5 is a flow chart showing the sequence of steps involved in subscribing to a contact management system in accordance with the present invention;

FIG. 6 is a flow chart showing the sequence of steps involved in the distribution of a business card to an intended recipient;

FIG. 7 is a flow chart showing the sequence of steps involved in the use of the business card in the contact management system of FIG. 2;

FIG. 8 is a flow chart showing the sequence of steps involved in contact management pursuant to a transaction;

FIG. 9 is a flow chart showing the sequence of steps involved in maintaining contact with the recipient pursuant to a transaction;

FIG. 10 is a flow chart showing the sequence of steps involved in procuring and distributing the multi-purpose business cards; and

FIG. 11 is a diagram illustrating the affinity relationships between the contact, the merchant and the recipient in accordance with the present invention.

### DETAILED DESCRIPTION OF THE INVENTION

Definitions

As defined herein, the term “contact” generally refers to any person, group, organization, business, or other type of identifiable entity. The term contact can also include or imply an interaction, connection, relationship or association, between two or more entities.

The term “contact information,” as used herein, generally includes information that corresponds to a contact and that may be considered relevant for identifying, contacting, accessing, corresponding or communicating with the contact. Contact information can also be defined as any information corresponding to a person or a business.

The term “e-commerce” or “electronic commerce” refers to the transacting, such as buying and/or selling, of wares or services on a communication network such as the Internet, or the World Wide Web.

The term “e-value” is used to describe electronic cash, credit, loyalty points or other type of value stored on a business card, which is readable or detected by visual, optical, magnetic, electronic or other means, and that can be redeemable in exchange for goods or services.

The term “secure” describes to data that is encoded using encryption or other means so as to ensure the integrity of the data, or data that is communicated in a channel while its integrity is safeguarded.

The term “point-of-sale” (POS) is meant to refer to an efficient recording of the data that comprises a business transaction at a physical (such as a store) or virtual (such as the World Wide Web) location where the sale of wares or services occurs.

The term “client” is meant to represent any local computing device such as an electronic cash register, personal computer, workstation, personal digital assistant, PIM, cellular or satellite phone, gas pump and payment machine, credit card or debit card transaction terminal, or any other device used for conducting a business transaction, which is capable of communicating with a remote computer or a server via a communication network such as the Internet, intranet, wireless network, local area network (LAN), wide area network (WAN), or the like. The communication through the communication network may be secure. The client may also include an input device such as a keyboard, keypad, pointing device, mouse, pen stylus, touch screen, voice recognition, biometrics or other such input devices as known in the art. The client may also include an output device such as a CRT screen, LCD screen, plasma display, or other similar output devices as known to those skilled in the art. The client may also include a peripheral data entry device such as a magnetic stripe reader, bar code reader, magnetic ink character recognition reader, optical character recognition reader, “smart card” reader, or other such peripheral data entry devices as known in the art. The client may also include a primary storage medium such as volatile memory and random access memory, and secondary memory device such as a hard drive disc, magnetic disc, where a client program is stored and executed upon demand on a central processing unit (CPU), a micro-controller or a master control unit (MCU). The client also has the capability to connect to the remote computer or server by a communication interface such as a modem, wireless network, LAN, WAN, or the like, as known to skilled artisans. The client program may reside and be executed on the server and remotely operated at the client.

The term “server” is meant to describe to any computer remotely located in relation to the client, and includes at least one central processing unit, primary and secondary storage media. The server also may include a network interface, one or more server applications that provide the logic for an online or automated application, and is typically part of a larger, distributed computing system. The server is often modeled as a component of a three-tier system, which includes a graphical user interface (GUI), an application or business logic server, and a resource manager for accessing data stored in a plurality of databases.

Unless defined otherwise, all technical and scientific terms used herein have the same meaning as commonly understood by one of ordinary skill in the art to which this invention belongs.

The present invention arises from the realization that although universally used and accepted, traditional business cards are prone to be neglected or discarded without any notification to the contact. The present invention seeks to overcome these drawbacks by providing a multi-purpose business card that includes the contact information of the contact, as well as an e-value that can be redeemable at a merchant at a POS in exchange for wares and/or services. The e-value associated with the business card serves as an incentive for the recipient to retain and use the business card. Moreover, the contact can monitor the use of the business card and in the event of extended periods of non-use or expenditure in the amount of the e-value, and offer to replace the card or replenish its e-value to ensure preservation and continued retention of the business card.

Various embodiments of the present invention are now described with reference to accompanying drawings, wherein like elements are designated by like reference numerals throughout the drawings.

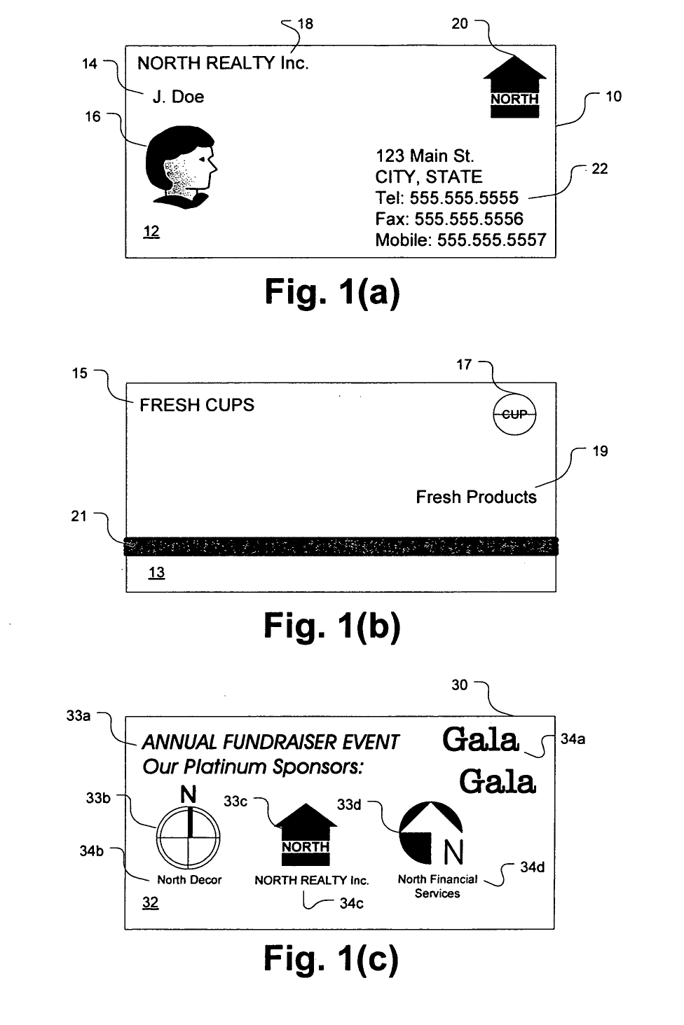

Reference is now made to FIGS. 1(a) and 1(b), which show a multi-purpose business card 10 in accordance with an embodiment of the present invention. The multi-purpose business card 10 generally comprises a printed card formed of rigid or laminated cardboard, and includes printed textual and/or graphical material on it. Although the business card can be of any desired size, it is favourably sized 3.5×2 inches so as to be conveniently stored in a wallet. Referring specifically to FIG. 1(a), there is shown a front side 12 of the business card 10. The front side 12 includes the contact information, namely the contact's name 14, picture 16, business or trade name of the entity associated with the contact 18, a business logo or trademark 20, as well as contact information 22 such as contact's telephone number, facsimile number, mobile phone number, e-mail address, website, mailing address, business logo, trademark, business affiliation or association, or the like. Alternatively, the contact is the entity sponsoring the contact's name 14, whereby the contact information includes business or trade name of the entity associated with the contact 18, or business logo or trademark 20 of the contact. Referring now to FIG. 1(b), the rear side 13 of the business card 10 is shown, which includes information about an affinity merchant associated with the contact, namely the merchant's trade or business name 15, the merchant's logo or trade-mark 17, contact information of the merchant 19, or other marketing information relating to the wares and/or services of the merchant. It is noted that the information relating to the affinity merchant is not restricted to the rear side 13. In an alternative embodiment of the present invention, the information relating to the merchant may also be depicted in the front side 12, to emphasize affiliation between the contact and the merchant.

The rear side 13 further includes a storage 21 where an e-value may be stored and replenished once exhausted. The e-value can be redeemed in consideration for goods and/or services offered by the merchant. In the presently described embodiment of the invention, the storage 21 is a magnetically readable stripe that is imprinted onto the rear side 13. However, the storage 21 may also be a bar code, an integrated circuit chip, a scratch-off foil overlying an offer, a sticker or label, or any other storage media for storing e-value or combinations thereof as contemplated by those skilled in the art.

As it can be appreciated, the multi-purpose business card is effectively a mini billboard to advertise or promote the contact information. Accordingly, the advertising space on the multi-purpose business card can be partitioned and allocated separately to a number of contacts. The contact information is not limited to one contact only, and contact information from several contacts can be depicted on the multi-purpose business card. FIG. 1(c) shows a multi-purpose business card 30 whereby contact informations 33a, 33b, 33c, 33d from a number of contacts 34a, 34b, 34c, 34d are depicted on the front side 32 of the multi-purpose business card 30.

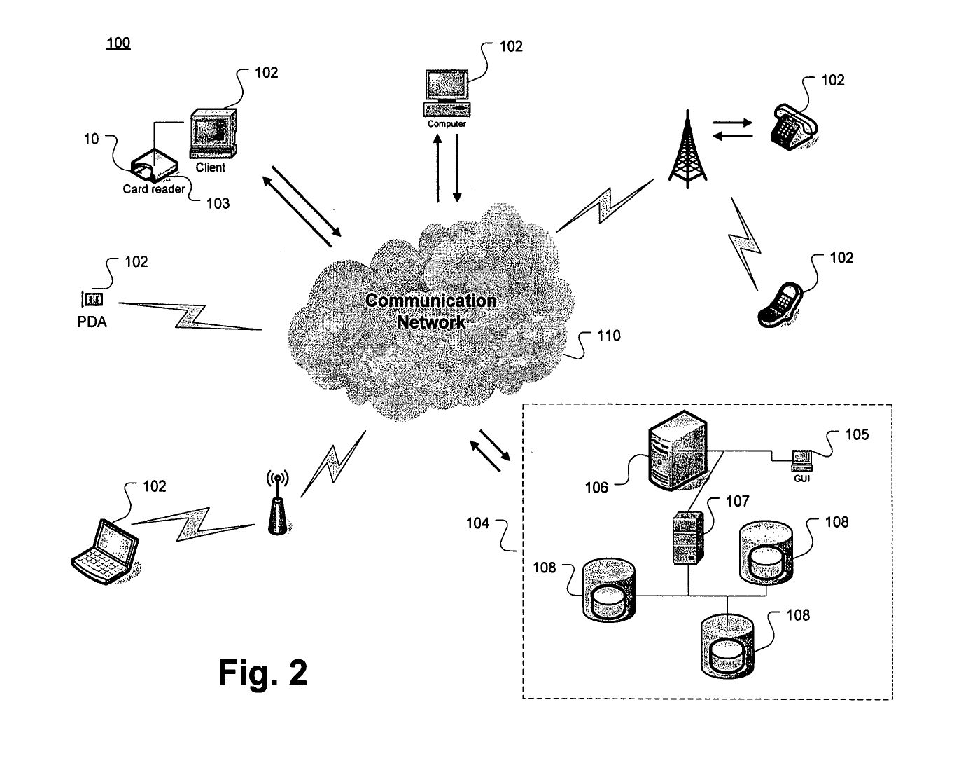

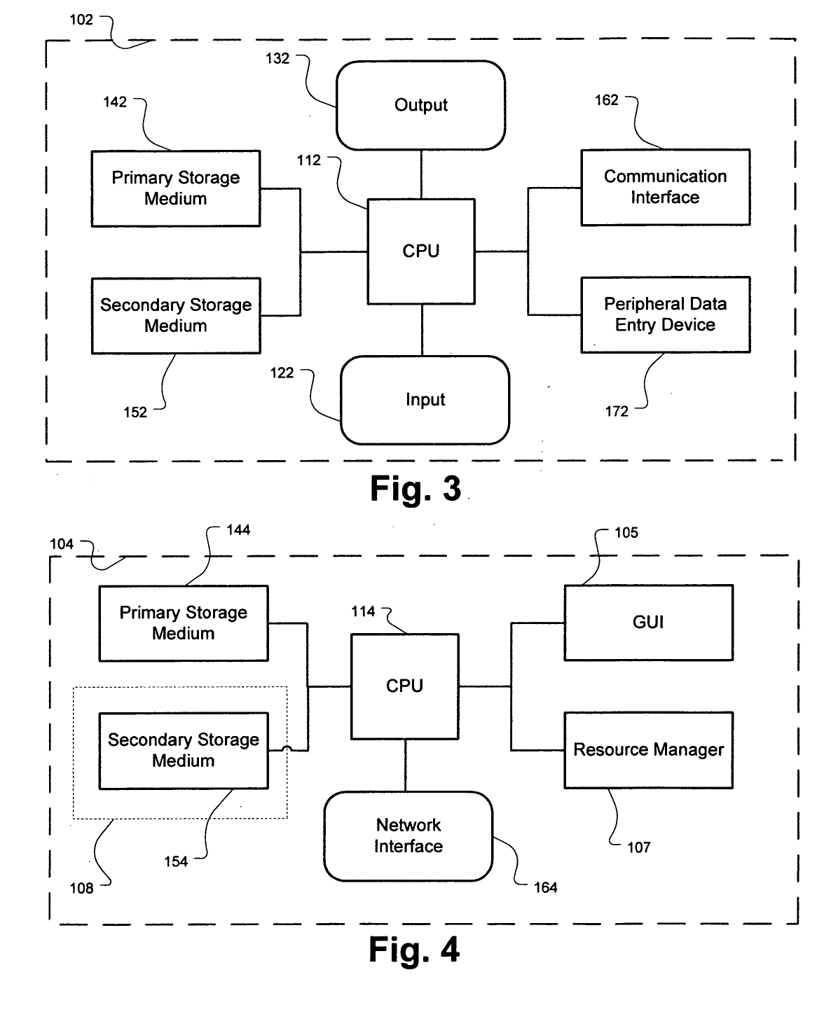

Reference is now made to FIG. 2, which illustrates a contact management system according to an embodiment of the present invention. The contact management system 100 is typically based on a client/server architecture and comprises a POS client 102 as the requesting machine and a server 104 that is the supplying machine, both of which are interconnected by way of a communication network 110, such as the Internet. The server 104 is a server computer and includes a graphical user interface (GUI) server 105, an application or business logic server 106, and a resource manager 107 for accessing data stored in databases 108. Each database 108 includes data for transactions relating to a particular merchant. The POS client 102 and server 104 are discussed in further detail in connection with FIGS. 3 and 4, respectively.

Referring still to FIG. 2, in a typical e-commerce transaction, a recipient at POS client 102 initiates an operation requesting a transaction such as purchase of a ware or service available at the client 102. The recipient initiates the transaction at the POS client 102 by spending the e-value in exchange for the ware or service. Typically, the recipient selects the ware or service of choice and the choice and balance of e-value remaining on the business card 10 are communicated to the client program running on the client 102 by way of a data input device such as a keypad or a data entry device such as a magnetic stripe reader as shown in FIG. 2.

The client program interacts with the server 104 that contains the business logic for synchronizing and managing access to data relating to the specific transaction located at one or more of the databases 108. The communication network 110 may be an intranet, or the Internet, depending upon the intended geographical reach of the system. The interface (not shown) between the business logic server 106 and the resource manager 107 may also be an intranet, the Internet, LAN, WAN, or any other type of proprietary network.

The resource manager 107 stores and retrieves data relating to the transaction on the databases 108 and forwards the requested data from the databases 108 to the server 104 for further processing, and the requested data is ultimately transmitted to the clients 102 by way of the communication network 110. The databases 108 may be co-located with the resource manager 107, and serve as archives of data pertaining to the transaction, such as the wares or services specifications, e-value price for the ware or service that is the subject of the transaction, wares or services availability, particulars of the recipient requisitioning the transaction, and other data related to an e-commerce transaction as contemplated by those skilled in the art, and the recipient's profile. As stored in a centralized database 108, the recipient's profile can include one or more data files having fields that define or otherwise include transaction-related information (such as the amount of e-value remaining on the business card 10, time schedule of use, etc.) corresponding to the recipient. The recipient's profile may also include the e-value associated with the business card 10, in the event that the e-value is not stored in the storage 21.

Based on the transaction data provided by the client program at POS client 102, the server application running on the server 104 accesses the data file relating to the recipient located on the merchant's database 108. The server application approves or denies the transaction and communicates this decision to the POS client 102 by way of the client program and updates the recipient's profile on the database 108. In accordance with the decision made by the server application, the POS client 102 authorizes or disapproves the requested business transaction. In an alternative embodiment of the present invention, decision as to whether to approve or decline the transaction may be predicated on metered values for the e-value associated with the business card 10. Accordingly, the server application compares the value of the ware or service subject of the transaction with e-value associated with the business card 10, and would allow expenditure of the e-value in predetermined amounts, thereby preventing the recipient to spend the entire e-value associated with the business card 10 on a single transaction.

Referring now to FIG. 3, a POS client is described pursuant to the definitions defined above in more detail herein. The POS client 102 includes a CPU 112 to execute programs such as the client program and to manage the operations of the client 102. An input device 122 interfacing with the CPU 112 provides for data entry for the client 102. Output device 132 also communicating with the CPU 112 displays data relevant to a specific operation or transaction performed by the client program. Primary storage medium 142 is coupled to the CPU 112 and is used for temporary storage of data and programs. Secondary storage medium 152 also coupled to CPU 112 is a bulk memory storage for permanent safeguard of programs and data. A communication interface 162 coupled to CPU 112 allows the POS client 102 to interface with the communication network 110 of FIG. 2 as can be contemplated by those in the art. The peripheral data entry device 172 interfacing with CPU 112 captures information such as e-value on a multi-purpose business card and communicates this information to CPU 112.

FIG. 4 illustrates a server in accordance to the definitions defined above in more detail herein. There is shown in FIG. 4 a server 104 in communication with the communication network 110 of FIG. 2 by way of a network interface 164. The server 104 has at least a CPU 114 for processing data. The server 104 receives, stores, and transmits data relating to the transaction being processed, as well as contact information, recipient profile information and various other data relating to a particular merchant. This data is accessed and saved in databases 108, which comprise the secondary storage medium 154 coupled to CPU 114. A primary storage medium 144 coupled with CPU 114 is used as a temporary storage for data processed by the CPU 144. The GUI 105 interfaces with CPU 114 and provides user interface, data entry and display for the server 104. The resource manager 107 stores and/or retrieves transaction data on the databases 108 and transmits data from the databases 108 to the server 104.

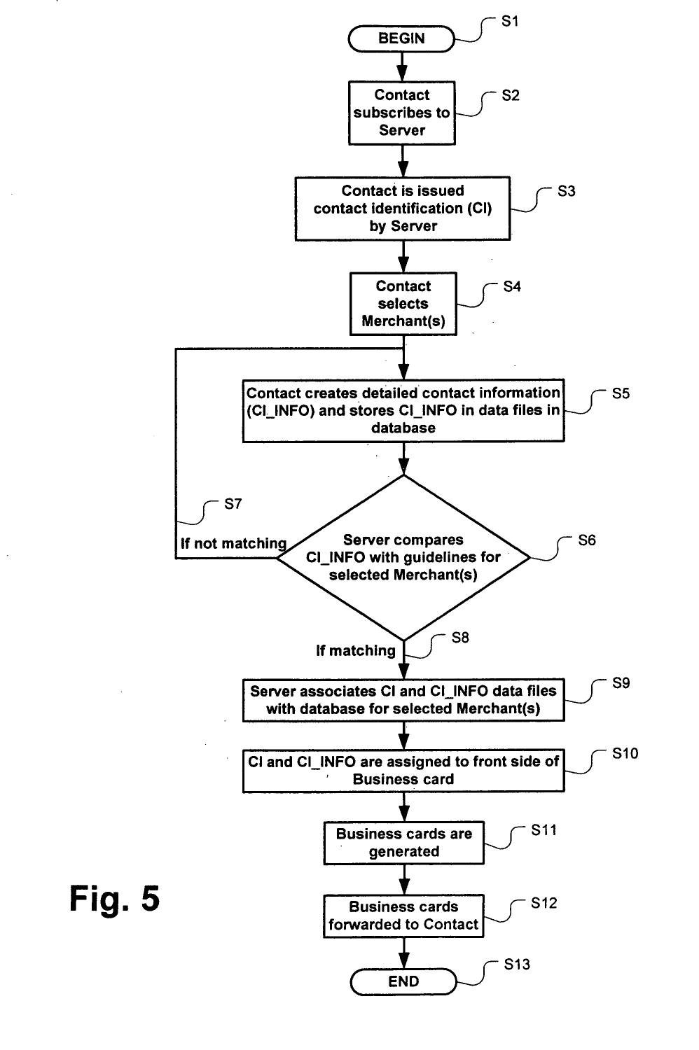

Referring now to FIG. 5, a sequence of steps for subscribing to a contact management system in accordance with the present invention is shown. First, a contact accesses the GUI 105 to subscribe to the server 104 (Step S2). The server 104 issues the contact a unique contact identifier (CI) (Step S3). Amongst the pool of participating merchants, the contact selects at least a merchant (Step S4). The contact subsequently creates detailed contact information CI_INFO associated with the CI. The CI_INFO is stored in a data file in a database 108 corresponding to the selected merchant (Step S5). At this juncture, the server application compares the CI_INFO with a set of pre-established guidelines associated with the selected merchant (Step S6). These guidelines may include restrictions on the type of contact business which may be associated with the selected merchant. For instance, a merchant may wish to preclude its direct competitors from association with the merchant. If the CI_INFO does not accord with the selected merchant's guidelines, the contact is prompted to redefine and recreate the CI_INFO (Step S7). In the event the CI_INFO is in agreement with the guidelines (Step S8), the server application associates the CI and CI_INFO data with the selected merchant (Step S9). The CI and CI_INFO data, as well as the merchant's information, are subsequently assigned to the front and/or rear sides 12 and 13 of the business card 10 (Step S10). The business cards 10 having the foregoing information captured on the front and rear sides 12 and 13 are generated (Step S11) and forwarded to the contact (Step S12) for distribution by contact in the course of conducting business intercourse.

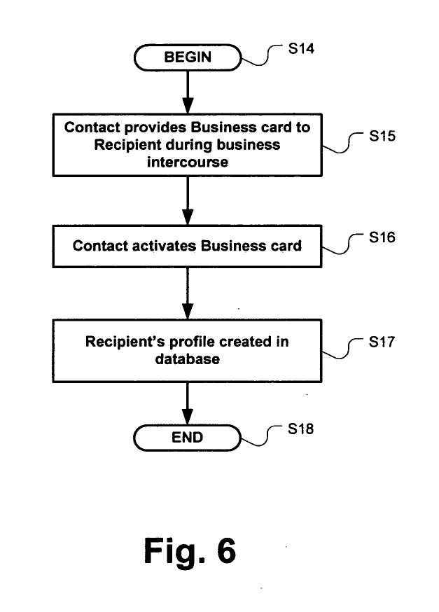

Referring now to FIG. 6, there is shown a sequence of steps for distribution of a business card 10 to a recipient. The process begins by contact handing out or forwarding the business card 10 to a recipient (Step S15). The contact subsequently activates the business card 10 (Step S16), whereby a recipient profile is created in the data files residing in the database 108 associated with the selected merchant (Step S17). Alternatively, the business card 10 may be pre-loaded with an amount of e-value.

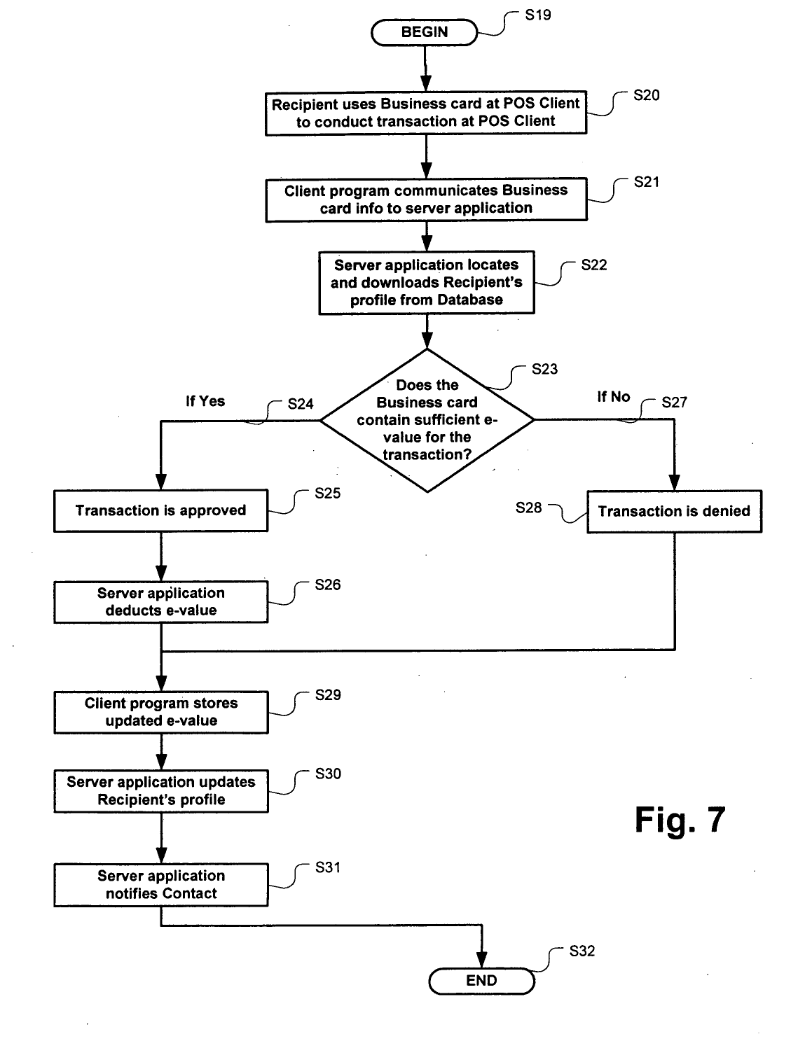

FIG. 7 illustrates the sequence of steps involved in the use of the business card 10 in the contact management system of FIG. 2. As shown in FIG. 7, a recipient uses the business card 10 at a POS client 102 associated with the selected merchant in order to effectuate a transaction at the POS client 102 (Step S20). The client program running at the client 102 captures the information on the business card 10 (such as the e-value, serial number of the business card 10, etc.) and communicates this information to the server application (Step S21). The server application locates and downloads the recipient's profile from the appropriate database 108 (Step S22). The server application then verifies whether the business card 10 contains sufficient e-value for the requested transaction (Step S23). If the amount of e-value residing on the business card 10 is equal or greater than the actual value of the ware or service that is the subject of the transaction (Step S24), the transaction is approved (Step S25). The server application deducts the face-value of the ware or service from the e-value and communicates this information to the client program (Step S26). If the amount of e-value associated with the business card 10 is less than the actual value of the ware or service that is the subject of the transaction (Step S27), the transaction is denied (Step S28) and the denial is communicated to the client program. The client program then updates the e-value on the business card 10 (Step S29). The server program updates the recipient's profile (Step S30) and subsequently notifies the contact (by way of, for example, a text message or an electronic e-mail) of the transaction (Step S31). Notification can be initiated based on an appropriate set of rules as pre-determined by the contact.

The e-value on the business card 10 can be pre-loaded on the card 10, activated by the contact at the time of the transaction from the GUI 105 shown in FIG. 2, or in the alternative, pre-authorized, but the contact is not yet charged for the e-value until the recipient makes the first business transaction with the business card 10, at which time the full amount of the e-value becomes automatically activated.

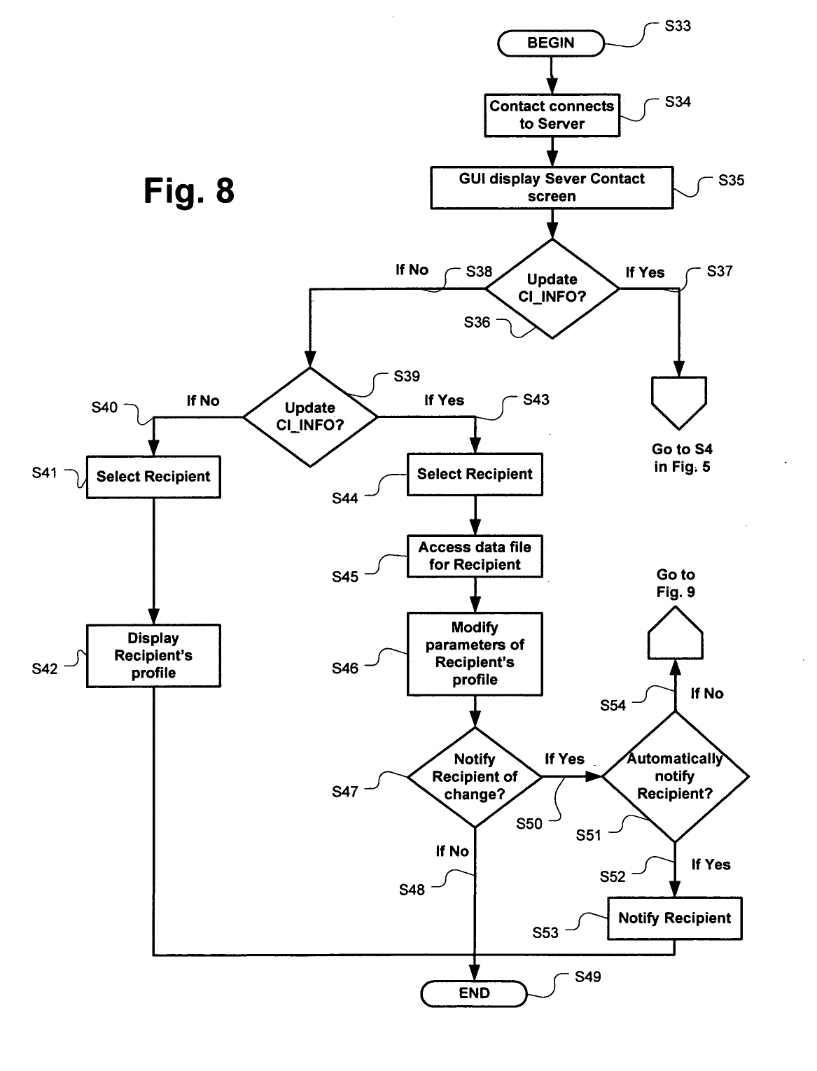

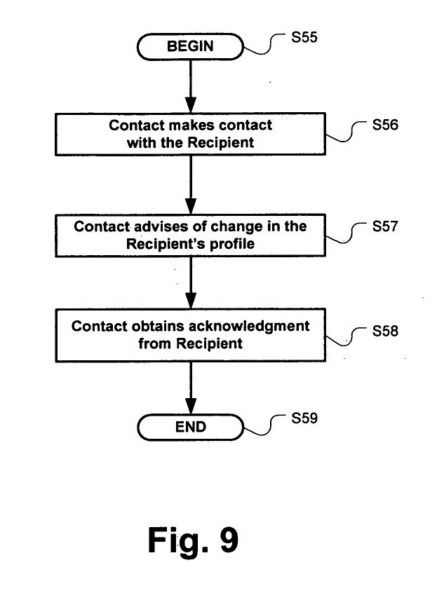

Reference is now made to FIG. 8, which shows the sequence of steps involved in contact management pursuant to a transaction. Once the contact has received notification of a transaction involving the recipient (as discussed in Step 31 of FIG. 7), the contact connects to the server 104 using the GUI 105 (Step S34). The GUI 105 displays the CI and CI_INFO (Step S35) and queries whether the contact wishes to update the CI_INFO (Step S36). If the contact requires updating the CI_INFO, the sequence of steps as described in Step S4 of FIG. 5 can be followed. However, if the contact does not request updating the CI_INFO (Step S38), the server application queries whether a recipient's profile requires updating (Step S39). In the event that no updating of recipient's profile is required (Step S40), then a particular recipient is selected (Step S41) and the recipient profile is displayed (Step S42). If the contact requires updating of a recipient's profile (Step S43), then the target recipient is selected (Step S44) and access to the recipient's profile is provided (Step S45). The contact can modify the parameters of the recipient's profile, such as block the recipient from conducting further transactions, increase or decrease the e-value credit for the recipient, etc. (Step S46). The server application then prompts the contact to advise whether to notify the recipient of these changes (Step S47). If a notification is not required (Step S48), the server application aborts (Step S49). If a notification to the user is required (Step S50), then the server queries whether the recipient should be automatically notified (Step S51). If an automatic notification is required (Step S52), then the recipient is notified of the changes to the profile (Step S53). However, if an automatic notification is not required (Step S54), then the sequence of steps as described in FIG. 9 can be followed.

FIG. 9 depicts the series of steps involved in maintaining contact with the recipient pursuant to a transaction. As shown in FIG. 9, the contact communicates with the recipient (Step S56) by way of e-mail, test message, personal visit, letter, telephone call or the like to advise changes to the recipient's profile (Step S57). The contact obtains confirmation or acknowledgement from the recipient (Step S58). As a result, the contact can maintain the existing link with the recipient.

As it can be appreciated from the implementation described in FIGS. 5 to 9, the contact benefits from the continuous use and promotion of the contact information by the recipient. Effectively, the multi-purpose business card acts as a constant reminder for the recipient of the contact information upon each use thereof. Further, any profits from sales of the merchant's wares or services associated with the multi-purpose business card are accrued to the merchant. The multi-purpose business card can be provided free of charge to the contact, or be sold at full e-value or at a rebate. In the event that the multi-purpose business card is sold to the recipient, the provider of the card gains profits from the actual sale. The provider can also receive royalties from the sale of wares or services purchased by the residual e-value on the card. The profits accrued to the provider can be even greater if the amount of e-value registered against the card is subsidized by the affinity merchant or the contact. Similarly, a buyer of the multi-purpose business card may obtain an e-value that is greater than the cost of the wares or services redeemable against the e-value, particularly if the amount of e-value is sponsored by the affinity merchant or the contact himself. Moreover, the promoter or the provider of the multi-purpose business card can obtain profits for production of the card.

The contact information may be related to a person or a business, or a number of persons, associations, or a number of businesses. In the event a number of persons or businesses are sponsoring the multi-purpose business card, the provider of the business card can receive payment for sale of the business card or royalties associated with the sale of wares or services from each person or business whose contact information is depicted on the multi-purpose business card. Similarly, a number of merchants can provide their wares or services in connection with the multi-purpose business cards, whereby each merchant may pay out a percentage of profits from wares or services sold in connection with the use of the business card to the provider or the contact.

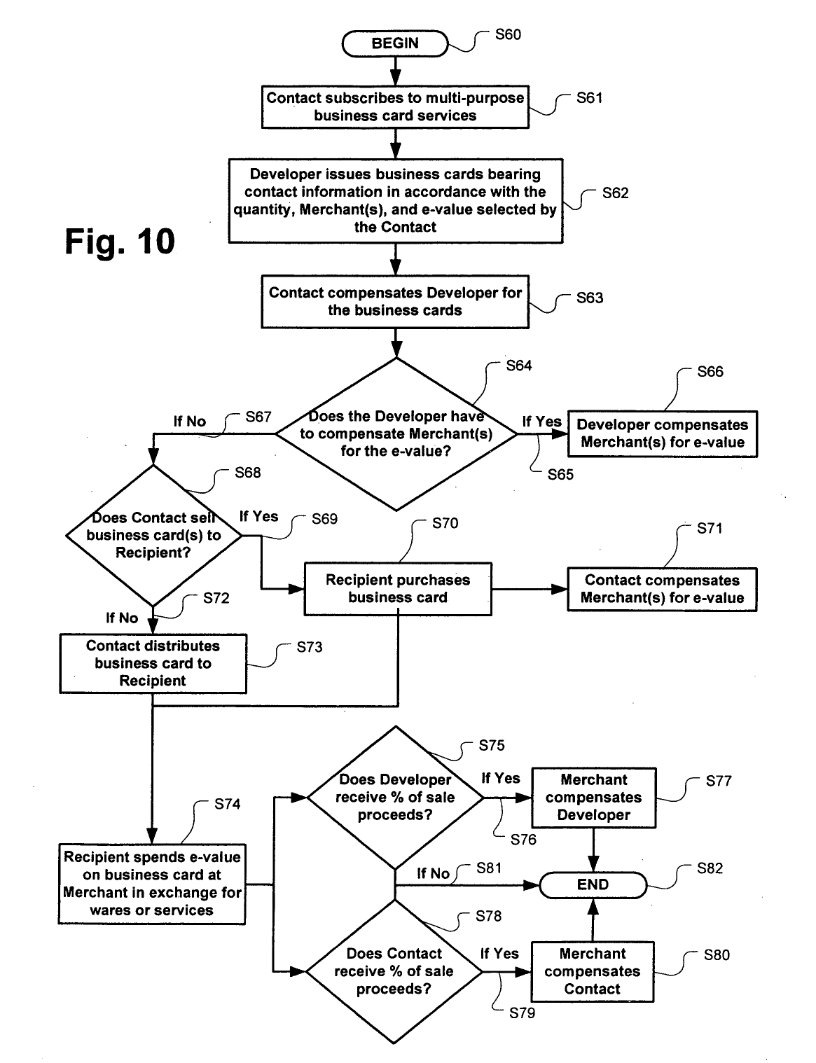

As it can be appreciated from the foregoing, there are numerous ways for the participants of the system to derive a revenue stream. Referring to FIG. 10, there is shown a sequence of steps typically involved in the procurement of multi-purpose business card service. Upon a contact subscribing to the multi-business card service (Step S61), a developer of the multi-purpose business card issues cards bearing contact information in accordance with the quantity, merchant(s), and e-value selected by the contact (Step S62). The contact compensates developer for the multi-purpose business cards obtained from the developer (Step S63). At this juncture, it must be determined whether the developer has to compensate the participating affinity merchant(s) for the e-value attached to the business cards sold to the contact (Step S64). In the affirmative (Step S65), then the developer compensates the merchant(s) for the e-value accordingly (Step S66). If not (Step S67), then a question arises as to whether the contact must sell the multi-purpose business cards to the intended recipients (Step S68). In the affirmative (Step S69), then business cards are sold to recipients (Step S70), and the contact compensates merchant(s) for e-value (Step S71). If no (Step S72), then the contact distributes business card to the recipient free of charge (Step S73).

As recipient spends e-value on business card at merchant in exchange for wares or services (Step S74), it must be determined (1) whether the developer receives a percentage of sale proceeds (Step S75); and (2) whether the developer receives a percentage of sale proceeds (Step S78). If the developer receives a percentage of sale proceeds (Step S76), then the participating merchant compensates the developer from the sale proceeds (Step S77). If the contact is to receive a percentage of sale proceeds (Step S79), then the participating merchant compensates the developer from the sale proceeds (Step S80).

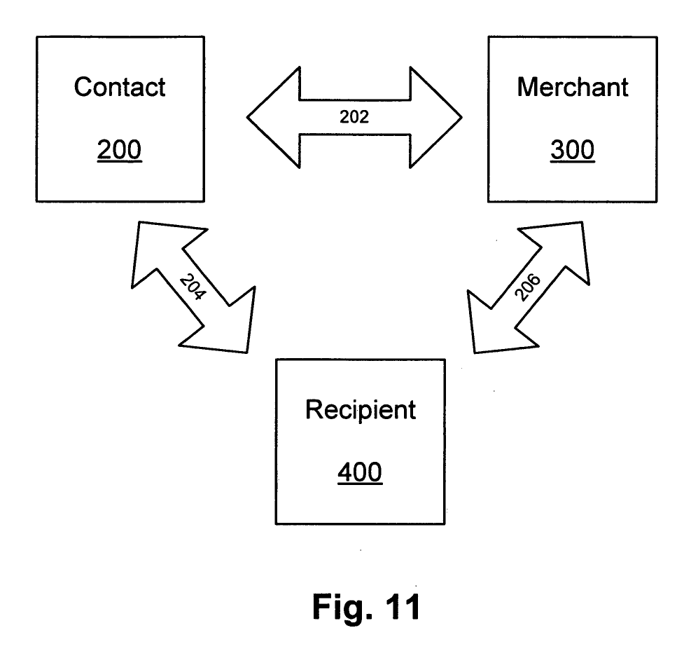

Reference is made to FIG. 11, which illustrates the affinity relationships created between the contact, the merchant and the recipient. As shown in FIG. 11, by using the multi-purpose business card, a contact 200 (such as a representative of an entity or the entity itself) creates an affinity relationship 202 with the merchant 300. An affinity relationship 204 is also created between the contact 200 and the recipient 400 of the multi-purpose business card each time the card is used. Moreover, by exchanging the e-value for wares or services of the merchant 300, an affinity relationship 206 is also created between the merchant 300 and the recipient 400.

It is obvious that the foregoing embodiments of the invention can be varied in many ways. Such present or future variations are not to be regarded as a departure from the spirit and scope of the invention, and all such modifications as would be obvious to one skilled in the art are intended to be included within the scope of the following claims.

1. A multi-purpose business card comprising a base layer defining a card, the base layer having a front side and a rear side, the front side including at least a contact information, and storage means having an e-value, the e-value being redeemable against a ware or service offered by at least a merchant.

2. The multi-purpose business card of claim 1, wherein the rear side includes information relating to at least a merchant.

3. The multi-purpose business card of claim 1, wherein the front side includes information relating to at least a merchant.

4. The multi-purpose business card of claim 1, wherein the at least a contact information includes information that corresponds to at least a contact and which is considered relevant for identifying, contacting, accessing, corresponding, or communicating with the at least a contact.

5. The multi-purpose business card of claim 1, wherein the at least a contact information includes information relating to at least a contact's telephone number, facsimile number, mobile phone number, e-mail address, website, mailing address, business logo, trademark, business affiliation or association.

6. The multi-purpose business card of claim 2 or claim 3, wherein the information relating to at least a merchant includes information from the list consisting of: the at least a merchant's trade name, business name, logo, trade-mark, contact information, promotional or marketing information relating to the ware or service of the at least a merchant.

7. The multi-purpose business card of claim 1, wherein the storage means are located in the rear side.

8. The multi-purpose business card of claim 1, wherein the storage means is a magnetically readable stripe, a bar code, an integrated circuit chip, a scratch-off foil overlying an offer, a sticker, or a label.

9. The multi-purpose business card of claim 1, wherein the front side includes a plurality of contact information for a plurality of contacts.

10. A method of contact management for at least a contact in an e-commerce system having a plurality of point-of-sale clients, each client having input and output means, storage means, peripheral means for reading at least a contact information on the at least a business card storage means, processing means executing a client program for communicating through a communication network through communication interface means with a server application executing on processing means, storage means having databases for storing information relating to at least a merchant and information relating to a business card recipient's profile in data files, the server further having resource management means and network interface means for communicating with the client program, and graphical user interface means for communicating data to the server application, the method comprising the steps of:
subscribing to the server;
issuing a contact identification by the server;
selecting at least a merchant;
creating the at least a contact information;
storing contact identification and at least a contact information in data files;
associating contact identification and the at least a contact information with the selected at least a merchant;
assigning contact identification and at least a contact information to the at least a business card; and
issuing the at least a business card.

11. The method of contact management of claim 10, further comprising the step of providing a business card to a recipient.

12. The method of contact management of claim 11, further comprising the step of activating the e-value for the at least a business card.

13. The method of contact management as of claim 12, further comprising the step of creating a profile for the recipient in the data files.

14-21. (canceled)

22. A computer readable memory having recorded thereon instructions for execution by a computer to carry out the method of claim 10.

23. A carrier wave embodying a computer data signal representing a sequence of instructions which, when executed by a processor cause the processor to carry out the method of claim 10.

24. (canceled)

25. A method of distribution of at least a business card for at least a contact in an e-commerce system having a plurality of point-of-sale (POS) clients, each client having input and output means, storage means, peripheral means for reading at least a contact information on the at least a business card storage means, processing means executing a client program for communicating through a communication network through communication interface means with a server application executing on processing means, storage means having databases for storing information relating to at least a merchant and information relating to the at least a business card recipient's profile in data files, the server further having resource management means and network interface means for communicating with the client program, and graphical user interface means for communicating data to the server application, the method comprising the steps of:
providing the at least a business card to a recipient; and
activating the business card by creating a recipient profile in the data files.

26. A method of distribution of at least a business card as set forth in claim 25, wherein the at least a business card is pre-loaded with an amount of e-value.

27. A method of distribution of at least a business card as set forth in claim 25, wherein the at least a business card is pre-loaded with an amount of e-value.

28. A computer readable memory having recorded thereon instructions for execution by a computer to carry out the method of claim 25.

29. A carrier wave embodying a computer data signal representing a sequence of instructions which, when executed by a processor cause the processor to carry out the method of claim 25.

30-39. (canceled)

40. A multi-purpose business card comprising
(a) a base layer defining a card, the base layer having a front side and a rear side, the front side including at least a contact information, and
(b) a storage medium comprising an e-value, the e-value being redeemable against a ware or service offered by at least a merchant.

41. The multi-purpose business card of claim 40, wherein the storage medium comprises a volatile memory or a random access memory.
